(19) United States
(12) Patent Application Publication
(10) Pub. No.: US 2011/0266506 A1
(43) Pub. Date: Nov. 3, 2011

(54) SILICONE SURFACE-TREATED MAGNESIUM HYDROXIDE

(75) Inventors: Koji Kodama, Shizuoka (JP); Kiyoshi Yagi, Susono-shi (JP); Makoto Egashira, Nagasaki-shi (JP); Haruhiko Furukawa, Ichihara-shi (JP)

(73) Assignees: YAZAKI CORPORATION, Tokyo (JP); Nagasaki University, National University Corporation, Nagasaki-shi (JP); DOW CORNING TORAY CO., LTD., Tokyo (JP)

(21) Appl. No.: 13/001,816

(22) PCT Filed: Jul. 2, 2009
(86) PCT No.: PCT/JP2009/062487

§ 371 Date: Mar. 9, 2011

(30) Foreign Application Priority Data
Jul. 2, 2008 (JP) 2008-173354

(51) Int. Cl. C09K 21/06

(52) U.S. Cl. 252/609

(57) ABSTRACT

Silicone surface-treated magnesium hydroxide which is surface treated by a silicone oil, the silicone oil comprising: a polyorganosiloxane containing a plurality of first siloxane units each of which contains hydrogen atom bonded silicon atom. The first siloxane units shares 50 mol % or less of total siloxane units in one molecule in average. Accordingly, sufficient fire retardancy and mechanical properties such as sufficient elongation are achieved.

### TECHNICAL FIELD

The present invention relates to silicone surface-treated magnesium hydroxide added to a crystalline thermoplastic resin such as a polyethylene resin and a polypropylene resin (those resins are hereinafter referred to as a “polyolefin resin”) as a fire retardancy additive agent, a polyolefin resin composition having the silicone surface-treated magnesium hydroxide added thereto, and a covered electric wire having a coating layer including the polyolefin resin composition.

### BACKGROUND ART

For a polyolefin resin such as polyethylene and polypropylene widely used as a base resin of a halogen-free coating material for an electric wire, addition of a large amount of a fire-retardant filler is required to improve considerably low heat-resistant properties of the resin. As the fire-retardant filler, magnesium hydroxide processed so as to have a hydrophobic surface is mainly used as a safe fire retardant having low smoke evolution at the combustion (see, for example, Patent documents 1 to 4).

In the related hydrophobicization process, a silane coupling agent such as vinylsilane and aminosilane, a higher fatty acid such as stearic acid, or phosphoric acid has been used as a hydrophobicizing agent.

However, a magnesium hydroxide having hydrophobicized surface is improved than magnesium hydroxide without hydrophobicization treatment, but causes to decrease in mechanical properties such as elongationelongation and flexibility of a base resin compounded. That is, there is a trade-off between mechanical properties (e.g. sufficient elongation) and sufficient fire retardancy.elongationelongation

The relationship between the addition amount of untreated and surface-treated magnesium hydroxides to a low density polyethylene base resin (low density polyethylene, manufactured by Prime Polymer) and the limiting oxygen index (LOI) is shown in Table 1. In Table 1, the commercially available surface-treated magnesium hydroxides were used other than cases where a methyl hydrogen silicone oil was used. Trade name: Magnifin is a product manufactured by Albemarle, trade name: KISUMA is a product manufactured by Kyowa Chemical Industry Co., Ltd., and trade name: Magseeds is a product manufactured by Konoshima Chemical Co., Ltd.

TABLE 1

| | Commercial | | | | | | | |
|---|---|---|---|---|---|---|---|---|
| | available | Addition amount (% by weight) | | | | | | |
| Surface-treating agent | product | 0 | 10 | 20 | 30 | 40 | 50 | 60 |
| None | Magnifin | 19.0 | 19.8 | 20.0 | 20.2 | 21.6 | 24.0 | 28.0 |
| Vinylsilane | Magnifin | — | 19.6 | 20.2 | 20.6 | 22.0 | 24.0 | 27.4 |
| Stearic acid | KISUMA 5A | — | — | — | 20.8 | 22.4 | 25.6 | 29.0 |
| Phosphoric acid | KISUMA 5A | — | — | — | 21.0 | 23.2 | 25.4 | 28.8 |
| Stearic acid | Magnifin | — | — | — | 20.6 | 22.4 | 24.8 | 27.8 |
| Aminosilane | Magnifin | — | — | — | 20.8 | 22.6 | 25.2 | 28.8 |
| Stearic acid | Magseeds | — | — | — | 20.4 | 22.4 | 24.4 | 27.8 |
| methyl hydrogen | Own product | — | — | — | 20.4 | 25.0 | 27.4 | — |
| silicone oil | | | | | | | | |

As seen from Table 1, unless the addition amount is 40% by weight or more, sufficiently high fire retardancy is not achieved in all cases. However, when the addition amount is 40% by weight or more, elongation is remarkably decreased in all of those systems.

### CITATION LIST

### Patent Literature

[PLT 1] JP-A 2002-285162
[PLT 2] JP-A-2001-226676
[PLT 3] JP-A-2003-253266
[PLT 4] JP-A-2003-129056

### SUMMARY OF INVENTION

### Technical Problem

It is predicted that methyl hydrogen silicone oil is chemically bonded to the surface of magnesium hydroxide by “Si—H” group in the molecule. In such a case, remarkable improvement was expected in mechanical performance and fire retardancy.

However, as a result of the actual investigations, the effect was not sufficiently exhibited as shown in Table 1.

The present invention has an object to provide a magnesium hydroxide fire retardant that improves the aforementioned and other problems. One of which is a magnesium hydroxide fire retardant that can impart sufficient fire retardancy by the addition thereof to a base resin while maintaining sufficient mechanical properties such as elongation, in view of the investigation results of the methyl hydrogen silicone oil and by achieving further high effect.

### Solution to Problem

According to one or more illustrative aspects of the present invention, there is provided a silicone surface-treated magnesium hydroxide which is surface treated by a silicone oil. The silicone oil includes a polyorganosiloxane containing a first siloxane unit each of which contains hydrogen atom bonded silicon atom, wherein the first siloxane units shares 50 mol % or less of total siloxane units in one polyorganosiloxane molecule in average.

Preferably, the first siloxane units shares 30 mol % or less of total siloxane units in one polyorganosiloxane molecule.

Preferably, the magnesium hydroxide is surface treated by a surface treatment comprises: mixing the silicone oil and the magnesium hydroxide into a mixture; and then conducting heat treatment to the mixture at a temperature from 80° C. to 250° C.

Preferably, the silicone oil is compounded in an amount of from 3 to 5 parts by weight per 100 parts by weight of the sum of the magnesium hydroxide and the silicone oil in the surface treatment.

Preferably, the number of repeating siloxane units in the silicone oil is on the average from 20 to 400.

Preferably, the magnesium hydroxide to be surface-treated with the silicone oil is magnesium hydroxide surface-treated with a higher fatty acid prior to the silicon oil surface treatment.

### Advantageous Effects of Invention

According to the present invention, sufficient fire retardancy is imparted by the addition of the magnesium hydroxide to a base resin, and at the same time, mechanical properties such as elongation are sufficiently maintained.

The fire-retardant polyethylene resin composition according to the present invention achieves sufficient fire retardancy and mechanical properties such as sufficient elongation, that are required in the formation of, for example, a fire-retardant electric wire covering layer, by the addition of a small amount of a magnesium hydroxide-based fire retardant.

The covered electric wire according to the present invention achieves sufficient fire retardancy and mechanical properties such as sufficient elongation by the addition of a small amount of a magnesium hydroxide-based fire retardant to the covering layer.

### BRIEF DESCRIPTION OF DRAWINGS

FIG. 1 is a graph showing the relationships between the value of n and the oxygen index, and between the value of n and the degree of elongation, in the fire-retardant polyethylene resin composition comprising a low density polyethylene base resin and a silicone surface-treated magnesium hydroxide compounded therewith in the evaluation result (1).

FIG. 2 is a graph showing the relationship between the compounding amount of the fire retardant and the degree of elongation in the evaluation result (3).

FIG. 3 is a graph showing the relationship between the compounding amount of the fire retardant and the oxygen index in the evaluation result (3).

### DESCRIPTION OF EMBODIMENTS

Magnesium hydroxide for the silicone surface-treated magnesium hydroxide of the exemplary embodiment is powdery magnesium hydroxide generally available as a fire retardant. For example, the such general magnesium hydroxide has a particle diameter of from about 0.1 to about 10 μm. Magnesium hydroxide already hydrophobicized with a higher fatty acid or its alkali metal salt, an anionic surfactant, phosphate ester, a silane coupling agent or a titanate coupling agent (for example, products available from Kyowa Chemical Industry Co., Ltd.) is available for the exemplary embodiment.

The silicone oil includes a silicon atom-bonded hydrogen atom-containing polyorganosiloxane which contains hydrogen atom-bonded silicon atom (that is, Si—H group). The content of a siloxane unit having Si—H group is on the average 50 mol % or less of siloxane units in one molecule. The siloxane unit having Si—H group can be located in a terminal siloxane unit and/or a siloxane unit in a polymer chain. The silicone oil is preferably a straight-chain siloxane polymer, and may partially contain a branched structure. The straight-chain siloxane polymer preferably contains a siloxane unit represented by RHSiO_{2/2}, and/or a siloxane unit represented by R₂XSiO_{1/2}, and a siloxane unit represented by R₂SiO_{2/2} in the molecule. In those formulae, R represents an unsubstituted or substituted monovalent hydrocarbon group having from 1 to 10, preferably from 1 to 8, carbon atoms, and X represents hydrogen atom or R. Examples of the monovalent hydrocarbon group include an alkyl group such as methyl group, ethyl group, propyl group, butyl group, pentyl group and hexyl group; a cycloalkyl group such as cyclopentyl group and cyclohexyl group; an aryl group such as phenyl group, tolyl group, xylyl group and naphthyl group; an aralkyl group such as benzyl group and phenetyl group; a halogen-substituted alkyl group such as 3,3,3-trifluoropropyl group and 3-chloropropyl group; and an alkenyl group such as vinyl group, allyl group and hexenyl group. Methyl group is preferred.

Example of the preferred silicone oil includes a dimethylsiloxne/methyl hydrogen siloxane copolymer having both ends capped with trimethylsiloxy groups, represented by the following chemical formula (I):

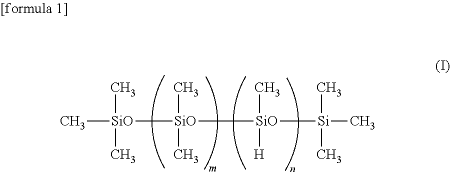

wherein m>0, n>0 and n/(m+n+2)≦0.5, 20≦m+n+2≦400 is preferred. The methyl hydrogen siloxane is an exemplary embodiment of the first silaxane unit. Also, m+n+2 represents an exemplary embodiment of the amount of total siloxane units.

When the content of the siloxane unit having Si—H group exceeds on the average 50 mol % of the siloxane unit in one molecule, the combination of sufficient fire retardancy and high mechanical properties may not be achieved. The content is preferably from 2.5% to 30%. The reason for this is that further excellent fire retardancy and further improved mechanical properties is achieved.

Thus, by the treatment with a silicone oil having the content of the siloxane unit having Si—H group of on the average 50 mol % or less of siloxane unit in one molecule, high performance is achieved as compared with the case of using a silicone oil of a polymer of a methyl hydrogen silicone unit alone. This fact cannot be predicted al all, and should be said to be a surprised effect.

The contents of the siloxane unit represented by RHSiO_{2/2}, the siloxane unit represented by R₂XSiO_{1/2}, and the siloxane unit represented by R₂SiO_{2/2} in the silicone oil can be measured by a method of heating the silicone oil together with KOH catalyst in tetraethoxysilane to hydrolyze the silicone oil, and quantitating alkyl ethoxysilanes obtained with gas chromatography, and by NMR (Nuclear Magnetic Resonance).

The number of repeating siloxane units per molecule in the silicone oil is preferably from 20 to 400 on the average. Where the number of repeating sloxane units is less than 20, the compound represented by the chemical formula (I) may easily evaporate. As a result, surface treatment of magnesium hydroxide may become difficult, and sufficient fire-retardant effect may be difficult to be achieved. On the other hand, where the number of repeating sloxane units exceeds 400, viscosity of the copolymer may increased. As a result, sufficient surface treatment may not be carried out, and fire-retardant effect may be difficult to be achieved.

Magnesium hydroxide is surface-treated with the copolymer (silicone oil). In the surface treatment, the silicone oil is mixed with magnesium hydroxide in an amount of from 3 to 5 parts by weight per 100 parts by weight of the sum of the magnesium hydroxide and the silicone oil.

In case where the amount of the silicone oil used is less than 3 parts by weight, it is difficult to combine fire-retardant effect and mechanical properties. In case where the amount of silicone oil used exceeds 5 parts by weight, commensurate effect with the amount used may not be achieved, and use of such a large amount may lead to unfavorable influence such as bleedout.

The silicone oil and the magnesium hydroxide are mixed by a method of spraying the silicone oil to the magnesium hydroxide, a wet surface treatment or a dry surface treatment, so that the silicone oil is deposited on the surface of the magnesium hydroxide particles as uniformly as possible. More specifically, the silicone oil is added while stirring the magnesium hydroxide using Henschel mixer or the like.

After mixing the silicone oil and the magnesium hydroxide, heat treatment is preferably conducted at a temperature from 80° C. to 250° C.

When the heat treatment at such a temperature is not conducted, the silicone oil and the magnesium hydroxide may be easily separated. In case where the heat treatment is conducted at a temperature higher than 250° C., the silicone oil may be decomposed. Heat treatment time is preferably from 10 minutes to 180 minutes. In case where the heat treatment time is shorter than 10 minutes, sufficient fire-retardant effect may not be achieved. In case where the heat treatment is conducted for a period of time exceeding 180 minutes, the commensurate effect with the extended heat treatment time may not be achieved.

Thus, the surface treatment is conducted using the silicone oil, and as a result, the silicone surface-treated magnesium hydroxide of the present invention is obtained.

The silicone surface-treated magnesium hydroxide is added to and mixed with a base resin, similar to the general hydrophobicized magnesium hydroxide.

Examples of the base resin used for an electric wire-covering halogen-free fire-retardant resin composition includes polyolefin resins such as a polyethylene resin compound and a polypropylene resin compound.

The silicone surface-treated magnesium hydroxide is mixed with the base resin using Banbury mixer, a roll mill, a twin-screw kneading machine or a pressure kneader so that components are sufficiently uniformed mixed.

When adding the magnesium hydroxide to the base resin, the following method may be used. The silicone surface-treated magnesium hydroxide is added to and mixed with the base resin in higher compounding ratio, not a compounding ratio in a final product. The resulting mixture is extrusion molded in pellets. The resulting pellets are added as a masterbatch when forming a final product (for example, extrusion molded around a core wire in the case of a covered electric wire).

The aforementioned silicone surface-treated magnesium hydroxide is preferably compounded in an amount of from 30% to 60% by weight based on the weight of the final resin composition in order to achieve sufficient fire retardancy and sufficient elongation. In case where the compounding amount is less than 30% by weight, sufficient fire retardancy may be difficult to be achieved. In case where the compounding amount exceeds 60% by weight, sufficient elongation may be difficult to be achieved.

### EXAMPLES

The silicone surface-treated magnesium hydroxide of the present invention is specifically described below by reference to the Examples.

### <Dimethylsiloxane/Methyl Hydrogen Siloxane Copolymer>

The dimethylsiloxane/methyl hydrogen siloxane copolymer, manufactured by Dow Corning Toray Co., Ltd., was used. The number of m and n in the chemical formula (I) is a value (average value) measured by heating the silicone oil together with KOH catalyst in tetraethoxysilane to hydrolyze the silicone oil, and measuring the quantity of alkyl ethoxysilanes which is obtained by hydrolysis with gas chromatography. When n or m is 0, it indicates that only one kind of a monomer is polymerized at the step of polymerization.

Other than the dimethylsiloxane/methyl hydrogen siloxane copolymer, polydimethylsiloxane (its chemical formula is shown by the chemical formula (II)) and polymethyl hydrogen siloxane were used as a silicone oil for surface treatment.

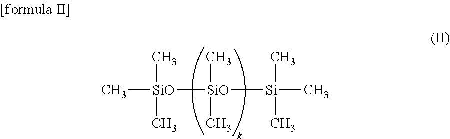

### <Preparation of Silicone Surface-Treated Magnesium Hydroxide>

The silicone oil was added to magnesium hydroxide (surface-treated with stearic acid, KISUMA 5AL, manufactured by Kyowa Chemical Industry Co., Ltd.) which is the commercially available fire retardant for resin mixing so as to be in a predetermined compounding ratio. The resulting mixture was heat-treated (150° C.) while stirring for 1 hour using Henschel mixer. Thus, silicone surface-treated magnesium hydroxide was obtained.

### <Fire-Retardant Resin Composition Containing Silicone Surface-Treated Magnesium Hydroxide>

The silicone surface-treated magnesium hydroxide was sufficiently uniformly dispersed in a low density ethylene base resin (MIRASON 3530, manufactured by Prime Polymer Co., Ltd.) at 130° C. using a roll mill so as to achieve a given compounding ratio.

### <Evaluation of Fire-Retardant Resin Composition>

The oxygen index (LOI) and degree of elongation were examined as the evaluation of the fire-retardant resin composition prepared above.

The oxygen index (LOI) was evaluated as follows. The fire-retardant resin composition was molded into a sheet having a thickness of 3 mm by pressure molding, and the sheet was punched into a strip. LOI of the strip was evaluated according to JIS K7201.

On the other hand, the degree of elongation was evaluated as follows. The fire-retardant resin composition was molded into a sheet having a thickness of 3 mm by pressure molding, and the sheet was punched out into a dumbbell to prepare a sample. The degree of elongation of the sample was evaluated according to JIS K6251.

### <Evaluation Result (1): Investigation of Existence Ratio of Units>

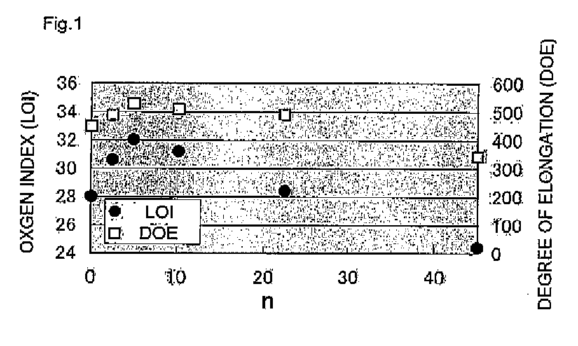

The silicone oil in which the sum of m and n, that is, the number of repeating siloxane units in the silicone oil, is 45 and the value of n is changed from 0 to 45 in the formula (1) was used. The silicone oil was compounded with magnesium hydroxide in an amount of 3 parts by weight per 100 parts by weight of the sum of the magnesium hydroxide and the silicone. Thus, the surface treatment was conducted. The silicone surface-treated magnesium hydroxide thus obtained was compounded with a low density polyethylene base resin in an amount of 40% by weight, thereby preparing a fire-retardant polyethylene resin composition. The relationships between the value of n and the oxygen index, and the relationships between the value of n and the value of n and the degree of elongation are shown in FIG. 1.

It is understood that when the silicone oil having the value of n in a range of from more than 0 to 22.5 (that is, the content of methyl hydrogen siloxane unit in dimethylsiloxane unit and methyl hydrogen siloxane unit in the molecular chain is 50 mol % or less) is used, high oxygen index and high degree of elongation are simultaneously achieved; and those results are very high as compared with the case of using polymethyl hydrogen siloxane (n=45) according to the prior art, and are higher than polydimethylsiloxane (n=0). Yield stress at the evaluation of the degree of elongation is from 10.2 to 11.2 in all samples, and is the same level.

### <Evaluation Result (2): Investigation of Compounding Ratio Between Silicone Oil and Magnesium Hydroxide>

Similar to the above, the silicone oil was compounded with magnesium hydroxide in an amount of 1 part by weight, 3 parts by weight and 5 parts by weight per 100 parts by weight of the sum of the magnesium hydroxide and the silicone oil represented by the formula (I). Thus, the surface treatment was conducted. The silicone surface-treated magnesium hydroxide thus obtained was compounded with a low density polyethylene base resin in an amount of 40% by weight, thereby preparing a fire-retardant polyethylene resin composition. Oxygen index of the fire-retardant polyethylene resin composition was investigated. The results are shown in Table 2.

TABLE 2

| | Compounded | | |
|---|---|---|---|
| | amount of | | |
| | silicone oil | | |
| | (parts by weight) | | |
| n | 1 | 3 | 5 |
| 0 | 24.8 | 28.0 | 31.6 |
| 2.5 | 24.8 | 30.6 | 31.8 |
| 5 | 26.0 | 32.0 | 31.6 |
| 10 | 25.0 | 31.2 | 32.2 |
| 22.5 | 25.0 | 28.4 | 27.8 |
| 45 | 24.8 | 24.4 | 25.2 |

It is understood from Table 2 that in the surface treatment, when the silicone oil is compounded in an amount of from 3 to 5 parts by weight per 100 parts by weight of the sum of the magnesium hydroxide and the silicone oil, particularly high oxygen index (27 or more) is obtained.

<Evaluation Result (3): Comparison with Other Surface-Treating Agent>

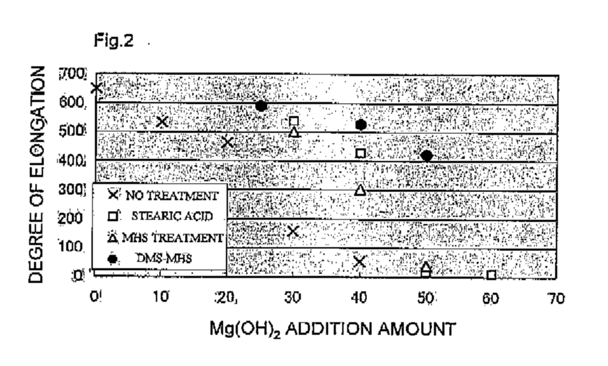

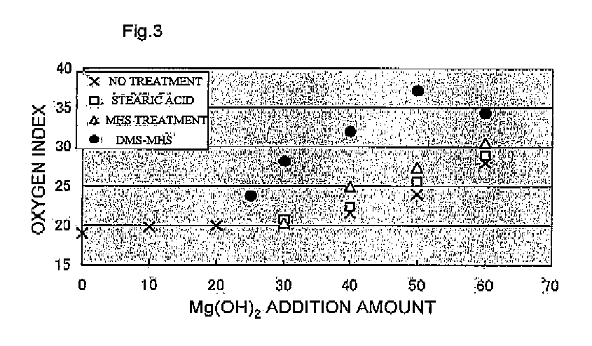

Magnesium hydroxide without surface treatment (MAGNIFIN H5, manufactured by Albemarle, hereinafter referred to as “no surface treatment”), magnesium hydroxide surface-treated with stearic acid (KISUMA 5AL, manufactured by Kyowa Chemical Industry Co., Ltd., hereinafter referred to as “stearic acid treatment”), silicone surface-treated magnesium hydroxide surface-treated by compounding polymethyl hydrogen siloxane (m=0 and n=45 in the formula (I)) in an amount of 3% by weight (hereinafter referred to as “MHS treatment”), or silicone surface-treated magnesium hydroxide surface-treated by compounding a dimethylsiloxane/methyl hydrogen siloxane copolymer (m=40 and n=5 in the formula (I)) in an amount of 3% by weight based on the weight of the silicone surface-treated magnesium hydroxide (hereinafter referred to as “DMS-MHS treatment”) was compounded with a base resin in an amount of 30% by weight, 40% by weight or 50% by weight. Thus, the respective fire-retardant polyethylene resin composition was obtained. The relationships between the compounding amount of the fire retardant and the degree of elongation and between the compounding amount of the fire retardant and the oxygen index are shown in FIG. 2 and FIG. 3, respectively.

It is understood that the fire-retardant polyethylene resin composition according to the present invention simultaneously achieves high oxygen index and high degree of elongation as compared with the case of using other fire retardants.

<Evaluation Result (4): Investigation with Silicone Oil Having Further High Molecular Weight>

Similar to the above (the case in the evaluation result (1)), silicone oils having the sum of m and n in the chemical formula (I), that is, the number of repeating siloxane units in the silicone oil, of 45, 90 and 360 (the values of n are 5, 10 and 40, respectively) were used. Each of those silicone oils was compounded magnesium hydroxide in an amount of 3% by weight or 5% by weight based on the weight of the resulting silicone surface-treated magnesium hydroxide (hereinafter referred to as “DMS-MHS treatment”). The silicone surface-treated magnesium hydroxide thus obtained was compounded with a base resin in an amount of 40% by weight. Thus, a fire-retardant polyethylene resin composition was obtained. The oxygen index of the composition obtained was evaluated. The results are shown in Table 3.

TABLE 3

Compounding
amount of
silicone oil
(parts by
weight)

| m + n + 2 | n | 3 | 5 |
|---|---|---|---|
| 45 | 5 | 32.0 | 31.6 |
| 90 | 10 | 32.8 | 31.2 |
| 360 | 40 | 29.8 | 32.5 |

It is understood from Table 3 that high oxygen index of about 30 or more can be obtained in the case of all of the above silicone oils.

<Evaluation Result (5): Investigation in Use of Magnesium Hydroxide without Treatment with Stearic Acid>

Similar to the above (the case of evaluation result (1)), a silicone oil having m of 40 and n of 5 in the chemical formula (I) was compounded with magnesium hydroxide without treatment with stearic acid (MAGNIFIN H5, manufactured by Albemarle) in an amount of 1% by weight, 3% by weight or 5% by weight based on the weight of the resulting silicone surface-treated magnesium hydroxide (hereinafter referred to as “DMS-MHS treatment”). The silicone surface-treated magnesium hydroxide thus obtained was compounded with a base resin in an amount of 40% by weight. Thus, a fire-retardant polyethylene resin composition was obtained. The oxygen index of the composition obtained was evaluated. As a result, the oxygen index is 25.6, 29.2 or 30.4, respectively, and it was confirmed that particularly high oxygen index is obtained in the addition systems of the silicone oil of 3% by weight and 5% by weight. Furthermore, the degree of elongation was evaluated. As a result, the result of the same level as the case of using magnesium hydroxide previously treated with stearic acid was obtained.

### <Evaluation Result (6): Investigation of Temperature at Surface Treatment>

Similar to the above (the case of evaluation result (1)), a silicone having m of 40 and a of 5 in the chemical formula (I) was compounded with magnesium hydroxide in an amount of 3% by weight based on the weight of the resulting silicone surface-treated magnesium hydroxide (hereinafter referred to as “DMS-MHS treatment”). The treatment temperature was 80° C. and 180° C. The silicone surface-treated magnesium hydroxide thus obtained was compounded with a base resin in an amount of 40% by weight. Thus, a fire-retardant polyethylene resin composition was obtained. As a result of evaluation of the oxygen index and the degree of elongation of the fire-retardant polyethylene resin composition, it was confirmed that the result is the same level as the case that the treatment temperature is 150° C.

### INDUSTRIAL APPLICABILITY

The fire-retardant polyethylene resin composition according to the present invention achieves sufficient fire retardancy and mechanical properties such as sufficient elongation, that are required in the formation of, for example, a fire-retardant electric wire covering layer, by the addition of a small amount of a magnesium hydroxide-based fire retardant.

This application claims priority from Japanese Application No. 2008-173354 filed on Jul. 2, 2008 and subject matters of which is incorporated herein by reference.

1. Silicone surface-treated magnesium hydroxide which is surface treated by a silicone oil, the silicone oil comprising:
a polyorganosiloxane containing a first siloxane unit which contains hydrogen bonded silicon atom, wherein the first siloxane units shares 50 mol % or less of total siloxane units in one polyorgampsiloxane molecule in average.

2. The silicone surface-treated magnesium hydroxide according to claim 1, wherein the first siloxane units shares 30 mol % or less of total siloxane units in one polyorganosiloxane molecule.

3. The silicone surface-treated magnesium hydroxide according to claim 1,
wherein the magnesium hydroxide is surface treated by a surface treatment comprises:
mixing the silicone oil and the magnesium hydroxide into a mixture; and
then conducting heat treatment to the mixture at a temperature from 80° C. to 250° C.

4. The silicone surface-treated magnesium hydroxide according to claim 3, wherein the silicone oil is compounded in an amount of from 3 to 5 parts by weight per 100 parts by weight of the sum of the magnesium hydroxide and the silicone oil in the surface treatment.

5. The silicone surface-treated magnesium hydroxide according to claim 1, wherein the number of repeating siloxane units in the silicone oil is on the average from 20 to 400.

6. The silicone surface-treated magnesium hydroxide according to claim 1, wherein the magnesium hydroxide to be surface-treated with the silicone oil is magnesium hydroxide surface-treated with a higher fatty acid prior to the silicon oil surface treatment.

7. A surface treatment of magnesium hydroxide comprising:
mixing a silicone oil and the magnesium hydroxide into a mixture; and
then conducting heat treatment to a mixture at a temperature from 80° C. to 250° C., wherein
the silicone oil comprising:
a polyorganosiloxane containing a plurality of first siloxane units each of which contains hydrogen atom bonded silicon atom, wherein the first siloxane units shares 50 mol % or less of total siloxane units in one molecule in average.

8. The surface treatment according to claim 7, wherein the first siloxane units shares 30 mol % or less of total siloxane units in one molecule.

9. The surface treatment according to claim 8, wherein the silicone oil is compounded in an amount of from 3 to 5 parts by weight per 100 parts by weight of the sum of the magnesium hydroxide and the silicone oil in the surface treatment.

10. The surface treatment according to claim 9, wherein the number of repeating siloxane units in the silicone oil is on the average from 20 to 400.

11. The surface treatment according to claim 7, further comprising:
surface treating the magnesium hydroxide with a higher fatty acid prior to mixing the silicon oil and the magnesium hydroxide.
